(19) United States
(12) Patent Application Publication
(10) Pub. No.: US 2005/0264917 A1
(43) Pub. Date: Dec. 1, 2005

(54) Method and apparatus for servo writing in a disk drive

(75) Inventors: Koji Yano, Ome-shi (JP); Koji Osafune, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/127,211

(22) Filed: May 12, 2005

(30) Foreign Application Priority Data
May 31, 2004 (JP) 2004-162085

(51) Int. Cl. G11B 21/02

(52) U.S. Cl. 360/75

(57) ABSTRACT

In a self-servo writing method, servo data is re-recorded, and thereby, servo data having worsened recording quality is rewritten. According to the method, the servo data is recorded in an entire range on a disk medium, and thereafter, the servo write direction is switched to re-record the servo data in a range to an intermediate circumferential area on the disk medium. In this way, the servo data is re-recorded to correct servo data having worsened recording quality.

### CROSS-REFERENCE TO RELATED APPLICATIONS

This application is based upon and claims the benefit of priority from prior Japanese Patent Application No. 2004-162085, filed May 31, 2004, the entire contents of which are incorporated herein by reference.

### BACKGROUND OF THE INVENTION

1. Field of the Invention

The present invention relates to a self-servo writing method of a disk drive. In particular, the present invention relates to a self-servo writing method applied to a perpendicular magnetic recording disk drive.

2. Description of the Related Art

In recent years, a rotary actuator rotating radially on a disk medium has been used in a disk drive such as hard disk drive. The tip end portion of the rotary actuator is attached with a magnetic head. The magnetic head has a write head (recording device) and a read head (reproduce device), which are mounted in a separated state.

Offsets equivalent to several tens of tracks exist between the write and read heads in the radial direction of the disk medium. Since servo data is recorded on the disk medium, head positioning control (servo control) is carried out using the servo data in the disk drive. The servo data is read by the read head, and used for the servo control.

The process of manufacturing the disk drive includes a servo writing process of recording servo data on a disk medium internally built in. The servo writing method used for the servo writing process is largely classified into two public-known methods. One is a method of using a dedicated servo track writer, and another is a self-servo writing method of using a head of a manufacturing object, that is, disk drive.

According to the self-servo writing method, the servo writing process is effectively realized at a relatively low cost. Therefore, technical research and development have been made (for example, see Japanese Patent No. 3083747 and No. 3238057).

According to the self-servo writing method, servo data is recorded over the entire circumference on the disk medium by the write head of the head attached to the rotary actuator built in the disk drive. In this case, a sector servo method is usually employed; therefore, the servo data is recorded on each data track on the disk medium at predetermined intervals.

Depending on the structure of the rotary actuator and the head, an inclination calling a skew angle occurs in the write head when recording the servo data on the disk medium. For this reason, the servo data is recorded in a state that spin transfer is inclined by the skew angle over the entire circumference. In particular, a single-pole head is used as the write head in the perpendicular magnetic recording disk drive; for this reason, the inclined state of the servo data remarkably appears.

In general, the servo data is recorded in the following manner in the servo writing process. More specifically, the servo data is recorded using the write head while the rotary actuator is moved from the innermost circumferential area to the outermost circumferential area on the disk medium. In this case, the inclination of the spin transfer of servo data becomes large in a range from the intermediate circumferential area to the outermost circumferential area on the disk medium in particular. As a result, this is a factor of generating a servo data area having worsened recording quality.

A bi-directional servo writing method has been publicly known as an effective technique of preventing the foregoing servo data recording quality failure. According to the method, servo data is recorded in a range from the innermost circumferential area where a skew angle on the disk medium becomes approximately zero degree to the vicinity of the intermediate circumferential area. Thereafter, the head is once moved to the outermost circumferential area, and then, the servo data is recorded in a range from the outermost circumferential area to the vicinity of the intermediate circumferential area.

However, the bi-directional servo writing method has the following problems. More specifically, several-track servo data having worsened recording quality occurs in the intermediate circumferential area if worse comes to worst. Moreover, a dedicated servo track writer is required to control head position; for this reason, the method is not applicable to the self-servo writing method.

### BRIEF SUMMARY OF THE INVENTION

In accordance with) an aspect of the present invention, there is provided a servo writing method, which can prevent servo data recording quality failure, and record servo data preferable recoding quality in a self-servo writing method.

A self-servo writing method of a disk drive including a disk medium, a head having read and write heads separated from each other and a rotary actuator equipped with the head, comprising:
a step of moving and controlling the rotary actuator using servo data read from the disk medium by the read head to position the write head;
a step of recording servo data in an entire range from the innermost circumferential area to the outermost circumferential area on the disk medium using the write head; and
a step of moving and controlling the rotary actuator to position the write head after servo data recording is completed in the entire range, and re-recording the servo data in a specified range on the disk medium using the write head.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view to explain a servo writing method according to an embodiment of the present invention;

FIG. 2 is a view showing the structure of a disk drive according to an embodiment of the present invention;

FIG. 3 is a view to explain the positional relationship between a read head and a write head according to the present embodiment;

FIG. 4 is a view to explain the positional relationship between a head and a data track in the present embodiment;

FIG. 5 is a view to explain the influence of skew angle in the data track in the present embodiment;

FIG. 6 is a view to explain the influence of skew angle in an inner circumferential area in the present embodiment;

FIG. 7 is a view to explain the influence of skew angle in an outer circumferential area in the present embodiment;

FIG. 8 is a view to explain a rewrite operation in the present embodiment; and

FIG. 9 is a flowchart to explain a servo writing method according to an embodiment of the present invention.

### DETAILED DESCRIPTION OF THE INVENTION

Embodiments of the present invention will be described below with reference to the accompanying drawings.

(Structure of Disk Drive)

As shown in FIG. 2, a disk drive of this embodiment has the structure in which disk medium 11, rotary actuator 13 and circuit board 16 are built to a drive cover 10. The disk drive of this embodiment is configured considering a state that servo data 100 is fully recorded in a servo writing process using a self-servo writing method described later before product delivery or a state before recorded.

The disk medium 11 is rotated at high speed by a spindle motor 12. The disk medium 11 is a perpendicular magnetic recordable medium. Before the disk medium 11 is built to the drive cover 10, reference servo data (or called as seed servo data) 100R is previously recorded to the innermost circumferential area on the disk.

The rotary actuator 13 is attached with a magnetic head (hereinafter referred simply to as head) 15 at the tip end portion. The rotary actuator 13 is moved radially on the disk medium 11 by a drive force of a voice coil motor (VCM) 14. In other words, the disk drive moves and controls the rotary actuator 13, and thereby, the head 15 is moved in a range from the innermost circumferential area to the outermost circumferential area.

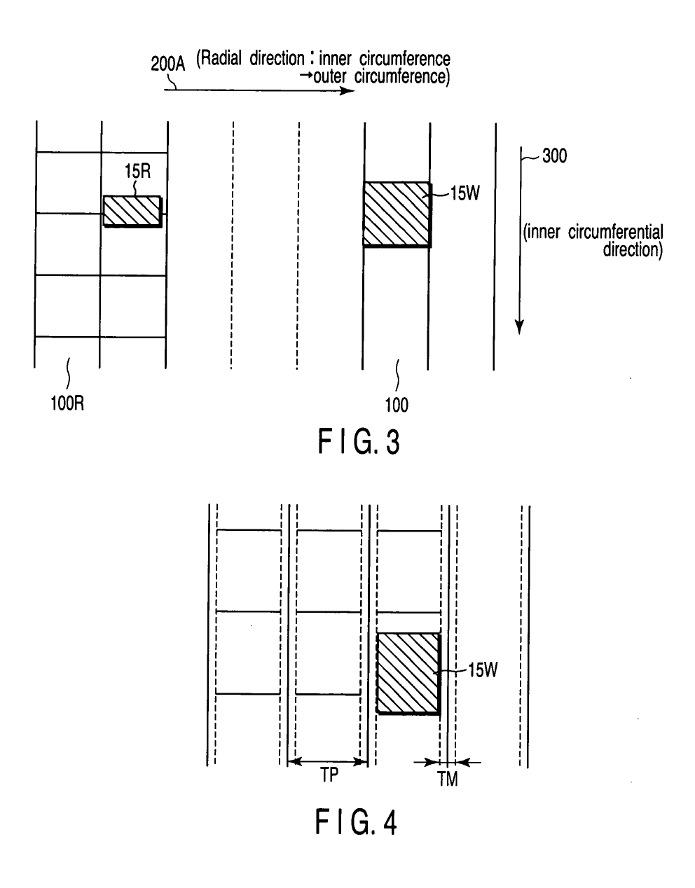

As depicted in FIG. 3, the head 15 has the structure in which a read head 15R reading data such as servo data and a write head 15W writing the same are mounted on the identical slider in a state of being separated from each other. The write head 15W of the embodiment is a single-pole head perpendicularly magnetic recordable with respect to the disk medium 11. Offsets equivalent to several tens of tracks exist between the read head 15R and the write head 15W in the radius direction of the disk medium.

The circuit board 16 is mounted with a head amplifier circuit for amplifying a read signal (e.g., servo data) outputted from the read head 15R or sending a write signal (e.g., servo data) to the write head 15W.

(Servo Writing Operation)

A self-servo writing operation will be described below. According to the self-servo writing operation, in the disk drive shown in FIG. 2, the internally built-in actuator 13 is moved and controlled. In this way, the servo data 100 is recorded to the disk medium using the head 15 attached to the actuator 13.

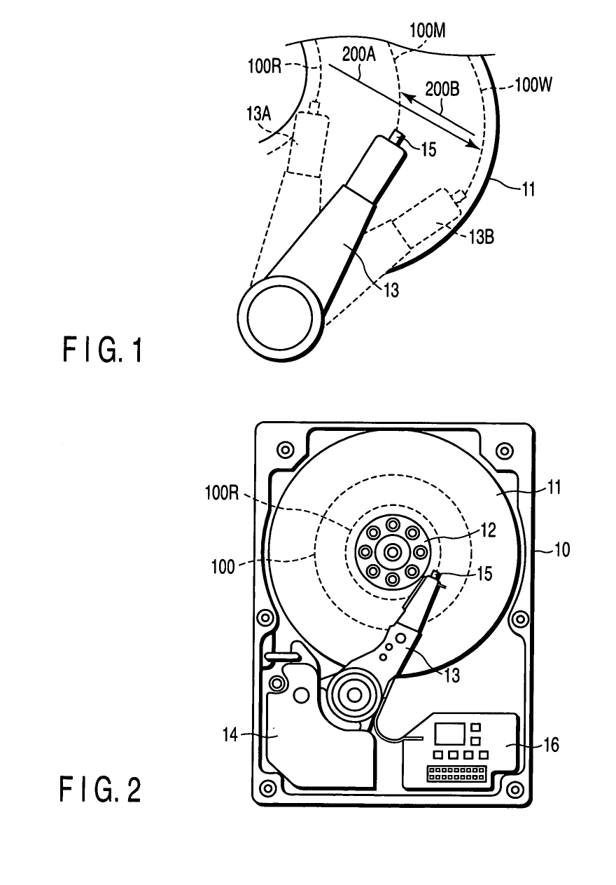

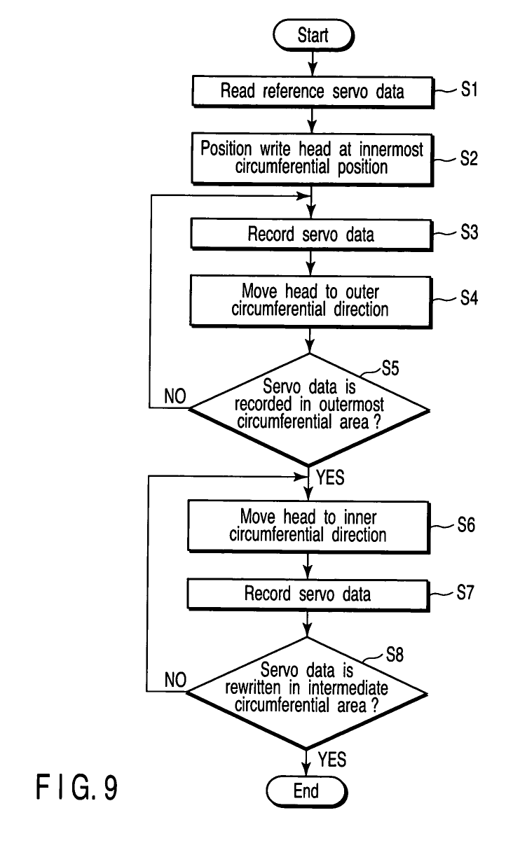

FIG. 1 is a view to explain the servo writing method of the present embodiment, and shows the moving tracks of the rotary actuator 13, that is, head 15. FIG. 9 is a flowchart to explain the procedures of the servo writing method.

As shown in FIG. 1, the actuator 13 is positioned above the innermost circumferential area on the disk medium 11 in the initial stage of the servo writing operation. Then, the actuator 13 is moved from the position 13A to the outermost circumferential area direction (200A). A disk drive controller reads reference servo data (seed servo data) 100R previously recorded on the innermost circumferential area on the disk medium 11 via the read head 15R of the head 15 (step S1). In this case, the controller means a microprocessor (CPU) provided inside or outside the disk drive, and software for executing the self-servo writing operation by the CPU.

As depicted in FIG. 3, the controller moves and controls the actuator 13 according to the reference servo data read via the read head 15R. In this way, the write head 15W is positioned at a specified position of the innermost circumferential area (step S2). In FIG. 3, a reference numeral 200A denotes a moving direction of the actuator 13 from the innermost circumferential area to the outermost circumferential area on the disk medium 11. A reference numeral 300 denotes a rotating direction of the disk medium 11.

The foregoing specified position is a position forming data tracks included in the innermost circumferential area in a data track group for recording user data. Thus, the product is delivered, and thereafter, the reference servo data 100R is left on the disk medium or deleted.

The controller writes and records servo data 100W via the positioned write head 15W (step S3). The servo data 100W is copy data of the reference servo data 100R or externally supplied write servo data.

The controller moves and controls the actuator 13 so that the head 15 travels to the outer circumferential direction 200A, and thereby, records the servo data 100W via the write head 15W in the same manner as above (step S4). The operation described above is repeated until the servo data 100W is recorded in the outermost circumferential area on the disk medium 11 (step S5).

When the actuator 13 moves to the outer circumferential direction, the read head 15R moves to an area where no reference servo data 100R is recorded. The controller reads the servo data 100W already written by the write head 15W via the read head 15R, and uses it for moving control (head positioning control) of the actuator 13.

In the manner described above, the actuator 13 moves from the position 13A of the innermost circumferential area to the position 13B of the outermost circumferential area on the disk medium 11. In this way, the servo data 100W is recorded in the entire range (effective recording range for recording user data) of disk medium 11. Incidentally, the disk drive of this embodiment is a sector servo type; therefore, the servo data 100W is recorded in the circumferential direction at regular intervals.

According to the servo writing method of the embodiment, the procedures (step S6 to S8) of rewriting (re-recording) the servo data are taken. More specifically, the controller moves the actuator 13 from the position 13B of the outermost circumferential area on the disk medium 11 to the inner circumferential direction (200B) as seen from FIG. 1. Then, the servo data is rewritten in an intermediate circumferential area (where servo data 100M is recorded) via write head 15W. The rewriting operation will be described below with reference to FIG. 1, FIG. 9, and FIG. 4 to FIG. 8.

In the rotary actuator 13, the head 15 has a skew angle when the actuator 13 is positioned above the innermost and outermost circumferential areas (13A) and (13B) on the disk medium 11 as shown in FIG. 1. The skew angle is a relative angle made by the head 15 and data track formed on the disk medium 11. The data track is a track formed when data is recorded based on the recorded servo data (also calling servo track).

When the actuator 13 is positioned above the intermediate circumferential area on the disk medium 11, the skew angle is approximately zero degrees. On the other hand, when the actuator 13 is positioned above the innermost or outermost circumferential area, the absolute value of the skew angle is approximately 10 degrees. In this case, the skew angle in the outer circumferential area is set as positive (+θ); on the other hand, the skew angle in the outer circumferential area is set as negative (−θ).

FIG. 4 shows the relationship between the head 15 (i.e., write head 15W) and data track when the skew angle is approximately zero degrees. Generally, in order to remove an influence to neighboring data track, both write and read heads 15W and 15R have a head width designed narrower than a track pitch TP. A track margin TM is interposed between the data tracks. When the skew angle is approximately zero degrees, spin transfer recorded by the write head 15W is a right angle to the data track. Thus, signal quality recorded or read (reproduced) by the head 15 is preferable, and no interference to neighboring data track occurs therein.

On the other hand, when the absolute value of the skew angle is approximately 10 degrees, recording is made in a state the write head 15W is inclined as illustrated in FIG. 5. For this reason, spin transfer 500 of the data track is inclined at an angle of 10 degrees. In this case, the read head 15R is inclined likewise; therefore, signal quality recorded or read to the data track is secured.

Part of the write head 15W makes phase-shift recording to the side of the track as seen from FIG. 5. In particular, the perpendicular magnetic recording single-pole magnetic head makes recording over the entire device surface; for this reason, it receives a large influence from the skew angle. In such a case, if the data track margin TM is small, there is a high possibility that data is overwritten to the edge of the neighboring track.

In the disk drive, the servo data recorded on the disk medium 11 is read (reproduced) to position the head 15 with respect to the data track as described before. Thus, the servo data is recorded with a pitch (e.g., ½ or ⅓ of data track) smaller than the data track. In this case, since the write head 15W has a head width wider than the servo track, overwriting is made, and thereby, the servo data is recorded. Therefore, no track margin is formed in a servo track comprising the recorded servo data.

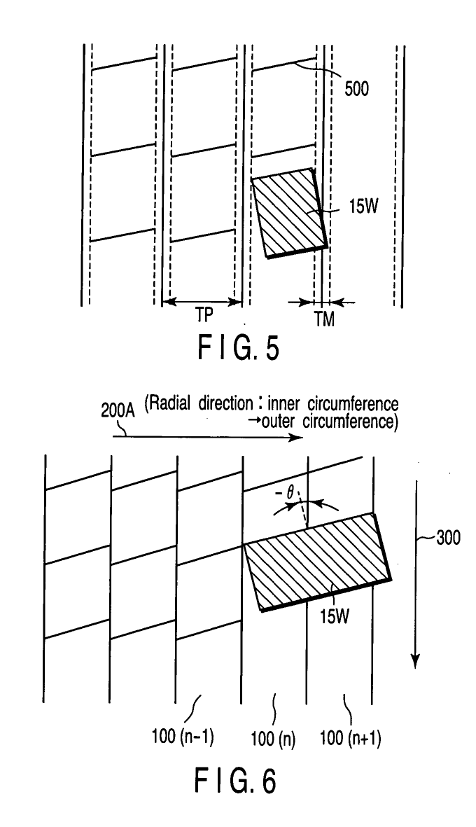

FIG. 6 shows a servo data recording state in the inner circumferential area on the disk medium 11. In this case, the skew angle of the write head 15W is approximately −10 degrees. As described before, the write head 15W moves from the inner circumferential area to the outer circumferential area direction 200A while overwriting and recording the servo data.

In FIG. 6, servo data of a servo track 100(n) is recorded in an area corresponding to an (n) cylinder. The write head 15W projects from the servo track 100(n); for this reason, the servo data of the servo track 100(n) is recorded in an area corresponding to a neighboring (n+1) cylinder. However, when the write operation of the servo data (100n) is completed, servo data of a servo track 100(n+1) is overwritten in the area (N+1); therefore, no problem arises.

On the other hand, when the traveling direction 200A of the head 15 is the same and servo data is recorded in the outer circumferential area, the skew angle of the write head 15W is approximately +10 degrees. In this case, part 700 of the write head 15W projects onto an already recorded servo track 100(n−1); for this reason, the servo data of the servo track 100(n) is overwritten therein.

In other words, the servo track has no track margin; for this reason, the projected write head 15W records the servo data (100n) to the edge of the servo track 100(n−1) as noise. In particular, the perpendicular magnetic recording single-pole head has a wider recording surface; for this reason, an influence by the noise remarkably appears. In this case, the servo data (100n) recorded to the servo track 100(n+1) has no problem resulting from noise because servo data of the servo track 100(n+1) is overwritten therein in the same manner as the case of FIG. 6.

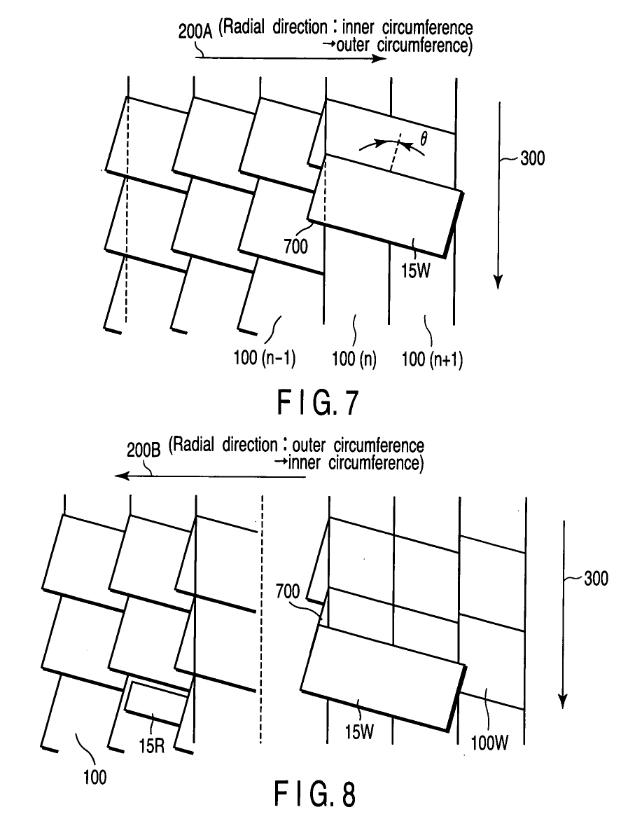

The inclination of spin transfer to the track pitch differs from FIG. 6 and FIG. 7. More specifically, In the case of FIG. 6, the spin transfer of servo data is formed so that the intermediate circumferential area is delayed in the outer and inner circumferential areas. On the other hand, the spin transfer of servo data is formed so that the intermediate circumferential area advances.

In short, when servo data is written toward the outer circumferential area from the innermost circumferential area, the servo data is overwritten in a neighboring track by the intermediate circumferential area having a skew angle of approximately zero. Therefore, there is no problem relevant to noise. However, in a range from the intermediate to the outermost circumferential areas, servo data given as noise is overwritten in part of the servo track recording servo data as described before, and intactly left therein. As a result, a servo track having worsened recording quality exists in the range from the intermediate to the outermost circumferential areas.

In order to solve the foregoing problem, a servo data rewrite (re-recording) operation is carried out according to the servo writing method of the embodiment. In this way, servo data having worsened recording quality including the noise is repaired (corrected) to improve the recording quality.

The servo data rewrite operation will be described below with reference to FIG. 1, flowchart of FIG. 9 and FIG. 8.

As shown in FIG. 1, the controller changes the servo writing direction when servo data is recorded to the outermost circumferential area, and then, moves the actuator 13 to the inner circumferential direction (220B) (step S6). The controller rewrites the servo data over a range from the outermost to the intermediate circumferential areas via the write head 15W (step S7, S8).

More specifically, as seen from FIG. 8, servo data is overwritten in the servo track already recording the servo data over the entire range via the write head 15W having the skew angle θ of +10 degrees. In this way, normal servo data is overwritten in the overwrite portion 700 including the noise; therefore, the noise is erased.

In this case, the skew angle θ is given; for this reason, part 700 of the write head 15W projects into the neighboring servo track in the inner circumferential direction. However, servo data of the neighboring servo track is overwritten; therefore, no problem relevant to noise arises.

As described above, the servo data is re-recorded in the intermediate circumferential area having a skew angle of approximately zero. In this way, the range from the outermost to the intermediate circumferential areas is corrected into servo data erasing the noise portion and having preferable recording quality. Therefore, according to the self-servo writing method having relatively high productivity, it is possible to realize a servo writing process of recording servo data having preferable recording quality on a disk medium.

Incidentally, the read head 15R reads servo data having worsened recording quality in the range from the outermost to the intermediate circumferential areas. However, disturbance influence such as vibration, temperature and humidity environments is removed as much as possible, thereby securing head positioning accuracy more than a predetermined level.

According to the present embodiment, servo data recorded in an inclined state depending on the skew angle of the head is rewritten. In this way, there is provided a servo writing method which can record servo data having preferable recording quality.

### Other Embodiment

The foregoing embodiment relates to the self-servo writing method. The re-recording operation is carried out after servo data in the entire range from the innermost to outermost circumferential areas is recorded using reference servo data (seed servo data) 100R previously recorded in the innermost circumferential area on the disk medium 11.

On the contrary, the following method may be employed as other embodiment. The re-recording operation is carried out after servo data of the entire range from the outermost to the innermost circumferential areas is recorded using reference servo data (seed servo data) previously recorded in the outermost circumferential area on the disk medium 11. Of course, in the re-recording operation, servo data is rewritten in a range from the innermost to the intermediate circumferential areas.

The re-recording (rewrite) operation of the present embodiment may be applied to a so-called full self-servo writing method given below. According to full self-servo writing method, servo data is recorded on the disk medium from the first without using reference servo data previously recorded on the disk medium 11.

If servo data is recorded in the entire range on the disk medium 11 according to the self-servo writing method, a servo data re-recording operation may be selectively carried out using a predictable range having worsened recording quality as a specified range.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A self-servo writing method of a disk drive including a disk medium, a head having read and write heads separated from each other and a rotary actuator equipped with the head, comprising:
a step of moving and controlling the rotary actuator using servo data read from the disk medium by the read head to position the write head;
a step of recording servo data in an entire range from the innermost circumferential area to the outermost circumferential area on the disk medium using the write head; and
a step of moving and controlling the rotary actuator to position the write head after servo data recording is completed in the entire range, and re-recording the servo data in a specified range on the disk medium using the write head.

2. The method according to claim 1, wherein in the re-recording step, the specified range is a range from the outermost or innermost circumferential area to an intermediate circumferential area on the disk medium.

3. The method according to claim 1, wherein the read head reads reference servo data recorded to the innermost circumferential area on the disk medium, and
the rotary actuator is moved and controlled using the reference servo data in the initial positioning by the write head.

4. The method according to claim 1, wherein in the step of positioning the write head, the rotary actuator is moved from the innermost circumferential area toward the outer circumferential area on the disk medium while the write head is positioned.

5. The method according to claim 1, wherein in the step of positioning the write head, the rotary actuator is moved from the innermost circumferential area toward the outer circumferential area on the disk medium while the write head is positioned, and
in the re-recording step, after servo data recording is completed in the entire range, the rotary actuator is moved from the outermost circumferential area to an intermediate circumferential area on the disk medium to position the write head, and the servo data is re-recorded in a specified range, that is, a range from the outer circumferential area to the intermediate circumferential area on the disk medium.

6. The method according to claim 1, further including:
a step of reading reference servo data recorded in the innermost circumferential area on the disk medium by the read head,
wherein in the step of positioning the write head, the rotary actuator is moved from the innermost circumferential area toward the outer circumferential area on the disk medium,
in the step of recording the servo data, the servo data is recorded in an entire range from the specified outer circumferential area to the intermediate circumferential area on the disk medium,
in the step of re-recording the servo data, after servo data recording is completed in the entire range, the rotary actuator is moved from the outermost circumferential area to the inner circumferential direction on the disk medium, and the servo data is re-recorded in a specified range by the write head.

7. The method according to claim 1, wherein a self-servo writing operation applied to the disk drive, which is a perpendicular magnetic recording type.

8. A disk drive comprising:
a disk medium for recording data;
a rotary actuator equipped with a head having read and write heads separated from each other, and moving in a radial direction on the disk medium;
first servo writing means for moving the rotary actuator using servo data read by the read head to position the write head, and recording the servo data in an entire range from the innermost circumferential area to the outermost circumferential area on the disk medium by the write head in a servo write operation; and
second servo writing means for moving the rotary actuator after servo data recording by the first servo writing means is completed, and re-recording the servo data in a specified range on the disk medium by the write head.

9. The disk drive according to claim 8, wherein the second servo writing means re-records the servo data in the specified range, that is, a range from the outermost or innermost circumferential area to an intermediate circumferential area on the disk medium.

10. The disk drive according to claim 8, wherein the disk medium is recorded with reference servo data in the innermost circumferential area,
the first servo writing means moves and controls the rotary actuator using the reference servo data read by the read head in the initial positioning of the write head, and
the second servo writing means re-records the servo data in the specified range, that is, a range from the outermost circumferential area to an intermediate circumferential area on the disk medium.

11. The disk drive according to claim 8, wherein the head has a single-pole head for recording data on the disk medium using perpendicular magnetic recording as the write head.
